(19) United States
(12) Patent Application Publication
(10) Pub. No.: US 2022/0183494 A1
(43) Pub. Date: Jun. 16, 2022

(54) ADAPTER FOR ATTACHING A DECORATIVE ORNAMENT TO A HOLIDAY LIGHT STRING, ORNAMENT INCORPORATING SAME, LIGHT STRING INCORPORATING SAME, AND METHOD OF USING SAME

(71) Applicant: Timothy A. LeBlanc, Rockford, MI (US)

(72) Inventor: Timothy A. LeBlanc, Rockford, MI (US)

(21) Appl. No.: 17/541,542

(22) Filed: Dec. 3, 2021

Related U.S. Application Data
(60) Provisional application No. 63/123,665, filed on Dec. 10, 2020.

(51) Int. Cl. A47G 33/08

(52) U.S. Cl. CPC A47G 33/0836

(57) ABSTRACT

An adapter, for use in attaching a translucent holiday ornament to a single lamp of a light string, includes a flexibly resilient main adapter body with a cylindrical sleeve and an annular cap integrally attached to an upper end of the sleeve. The annular cap has a central opening formed therein to receive the lamp. The adapter further includes attachment structure which may be a resilient wire member having a C-shaped upper portion, a pair of parallel connectors which extend from opposite ends of the upper portion, and a pair of non-parallel retaining members respectively attached to ends of the connectors which are spaced away from the upper portion. The adapter allows a user to retrofit an existing holiday light string, by permitting selective attachment or one or more transparent or translucent ornaments to individual lights on the light string.

### CROSS-REFERENCE TO RELATED APPLICATIONS

This application is based upon, and claims the benefit of priority from U.S. Provisional Patent Application No. 63/123,665, filed Dec. 10, 2020. The entire contents of the priority application, including specification and drawings, are incorporated herein by reference.

### BACKGROUND OF THE INVENTION

### Field of the invention

The present invention relates to an adapter for use in attaching a translucent ornament to an individual lamp on holiday light string, and also to an ornament incorporating the adapter, to a light string incorporating the adapter, and to a method of using the adapter to attach a transparent or translucent ornament to a conventional holiday light string.

### Description of the Background Art

Decorative and expensive ornaments may fall and break when hung from a holiday tree, due to poor hanging practices. Lighted ornaments require AC or DC power. Electrified ornaments are expensive and cumbersome, requiring redundant wiring and/or batteries, and also usually requiring individual off and on manual control.

Current ornament wire or string attachment devices may fail or get lost, and a user of such attachment devices may have to purchase replacement clips, caps, springs and wire parts that require repeated handling, assembling, and potential frustration.

Many people have lost expensive, decorative, and/or keepsake ornaments due to breakage caused by poor hanger devices. Pets, children, and disadvantageous placement of an ornament on a tree are some contributing causes leading up to such losses.

Conventional ornaments have used many different types of hangers which may include tiny wires, metal caps, springs, hooks, and/or strings, offering limited security, especially with exposure to children and pets. Separate AC or DC power may be required to illuminate some of the known illuminated ornaments.

Many ornaments only reflect light, thus without displaying intricate artwork which many ornaments contain, or are lost in the shadows of their setting, which may fail to properly display some ornate expensive ornaments.

Examples of some patents relating to decorative illuminated ornaments or similar articles include U.S. Pat. No. 5,361,192 (Lai), U.S. Pat. No. 5,772,312 (Pihl-Nederman), U.S. Pat. No. 7,448,773 (Lai), U.S. Pat. No. 9,278,574 (Zhang), and U.S. Pat. No. 10,021,943 (Ferris).

Although the known decorative articles are usable for their intended purposes, a need still exists in the art for a simple and inexpensive adapter which is usable to combine translucent or transparent holiday ornaments with conventional light strings.

### SUMMARY OF THE INVENTION

Accordingly, it is an object of the present invention to provide for a simple and inexpensive adapter which is usable to combine translucent or transparent holiday ornaments with conventional light strings.

It is another object of the invention to provide a combined ornament and adapter assembly, in which the adapter is pre-installed on the neck of the ornament.

It is still another object of the invention to provide a decorative holiday light string, comprising a multiplicity of light assemblies interconnected by wiring, and a plurality of translucent holiday ornaments attached to some or all of the light assemblies.

It is a further object of the invention to provide a method of connecting a translucent holiday ornament to a lamp assembly of a light string.

An illustrative embodiment of the present invention provides an adapter for use in attaching a translucent holiday ornament to a single lamp assembly of a light string. The adapter according to the first illustrative embodiment includes a main adapter body, formed from a flexibly resilient material and having a cylindrical sleeve and an annular cap integrally attached to an upper end of the sleeve. The annular cap has a central opening formed therein to receive a portion of a lamp assembly therethrough, and may also include a plurality of slits extending outwardly from the central opening toward the annular cap.

Optionally, the adapter may further include attachment structure which is either an adhesive material or a resilient wire member which fits inside of the main adapter body.

The adapter according to the first aspect of the present invention allows a user to retrofit an existing holiday light string, by permitting selective attachment or one or more transparent or translucent ornaments to individual lights on the light string.

Where a wire member is used for the attachment structure, the wire member may include an upper portion which is substantially C-shaped and disposed in a first plane, a pair of parallel connectors which are integrally formed with, and extend from opposite ends of the upper portion in directions which are substantially perpendicular to the first plane, and a pair of non-parallel retaining members configured for placement inside of said holiday ornament, the retaining members integrally formed with, and extending outwardly from ends of the connectors which are spaced away from the upper portion.

Ornament breakage by pets, children, and handling will be reduced or minimized when using the adapter according to the invention.

The adapter design according to the present invention is configured to be attached once to the ornament, and lasts essentially the entire life of the ornament without any additional parts to lose, break, or mismatch. The adapter secures the ornament to the light source better than other known devices, and enables lighting of ornaments without requiring separate power.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a perspective view of a portion of a holiday light string having translucent ornaments selectively attached thereto, according to a first illustrative embodiment of the present invention.

FIG. 2 is a cross-sectional detail view, partially cut away, through one of the ornaments on the light string of FIG. 1, showing an adapter and lamp assembly according to the first embodiment.

FIG. 3 is an exploded perspective view of the ornament, adapter of and lamp assembly of FIG. 2.

FIG. 4A is a first perspective view of a main adapter body, and FIG. 4B is a second perspective view thereof.

FIG. 5A is a perspective view of a resilient wire attachment member which is a component of the adapter of FIG. 3, and FIG. 5B is a top plan view thereof.

FIG. 6 is a perspective view of the main adapter body of FIG. 4A with a resilient wire attachment member attached thereto; and

FIG. 7 is a cross-sectional detail view, partially cut away, through one of the ornaments on the light string of FIG. 1, showing an adapter according to a second embodiment of the present invention attaching a lamp assembly to the ornament.

### DETAILED DESCRIPTION

It should be understood that only structures and methodology needed for illustrating selected embodiments of the present invention are described herein. Other conventional structures, and those of ancillary and auxiliary components of the system, will be known and understood by those skilled in the art.

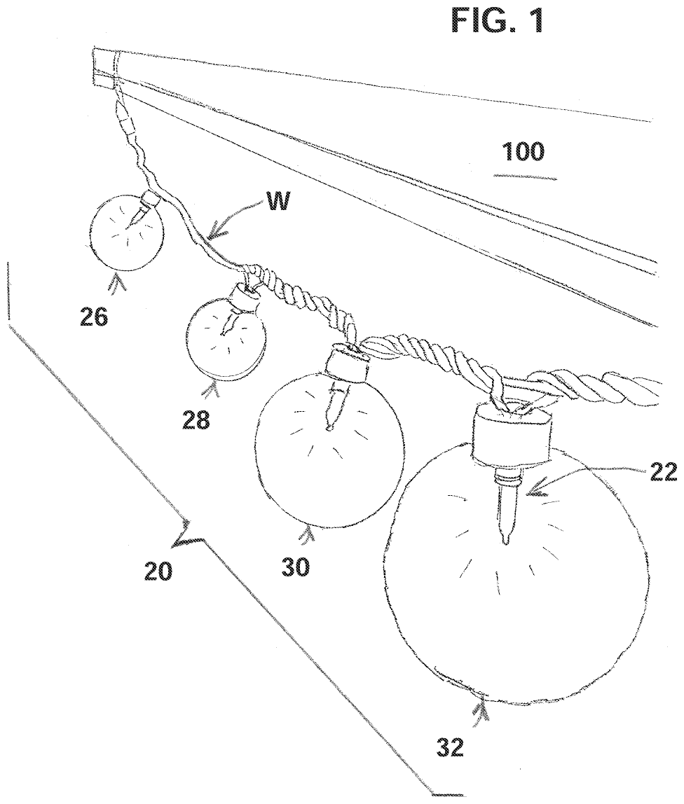

Referring now to FIG. 1, a portion of a holiday light string is shown generally at 20. The light string 20 is supported on a support member 100, and has a number of translucent ornaments 26, 28, 30 and 32 selectively attached thereto, using adapters according to a first illustrative embodiment of the invention.

The light string 20 includes a multiplicity of lamp assemblies 22 interconnected by wiring W, and four of the lamps are shown inserted into the translucent ornaments 26, 28, 30 and 32.

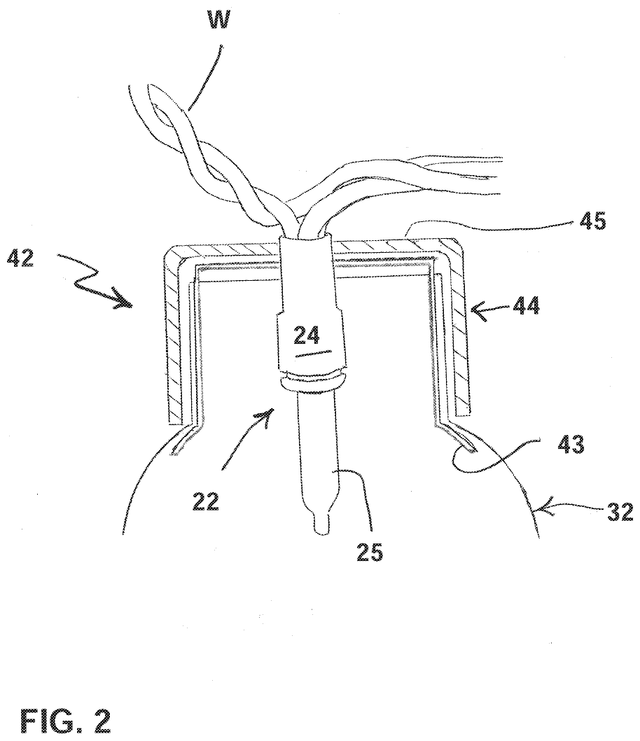

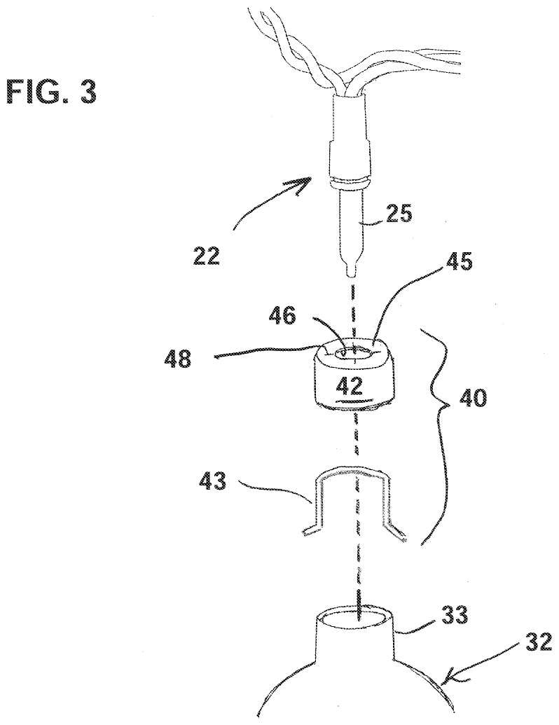

Referring also to FIGS. 2-3, it will be seen that each lamp assembly 22 includes a socket 24 and a bulb 25, and the lamp assembly 22 is shown attached to an ornament 32 with an adapter 40 according to a first aspect of the present invention.

The adapter 40, according to the first aspect of the present invention, allows a user to retrofit an existing holiday light string by permitting selective attachment or one or more transparent or translucent ornaments, such as the ornaments shown at 26, 28, 30 and 32, to individual lamp assemblies on the light string.

The adapter 40 may be made in different sizes, as appropriate, to conform to the necks 33 of different sized ornaments 32.

As shown in FIGS. 2-3, it will be seen that in this first embodiment, the adapter 40 includes a main adapter body 42 and a resilient wire member 43, which serves as an attachment structure. The adapter 40 is provided for use in attaching a translucent holiday ornament, such as that shown at 32, to a single lamp assembly 22 of a light string 20.

Ornament breakage by pets, children, and handling will be reduced or minimized when using the adapter 40 according to the invention.

The main adapter body 42 is formed from a flexibly resilient material, which may be elastomeric and which may include nitrile rubber, Neoprene, natural rubber and/or other suitable elastic or elastomeric compounds.

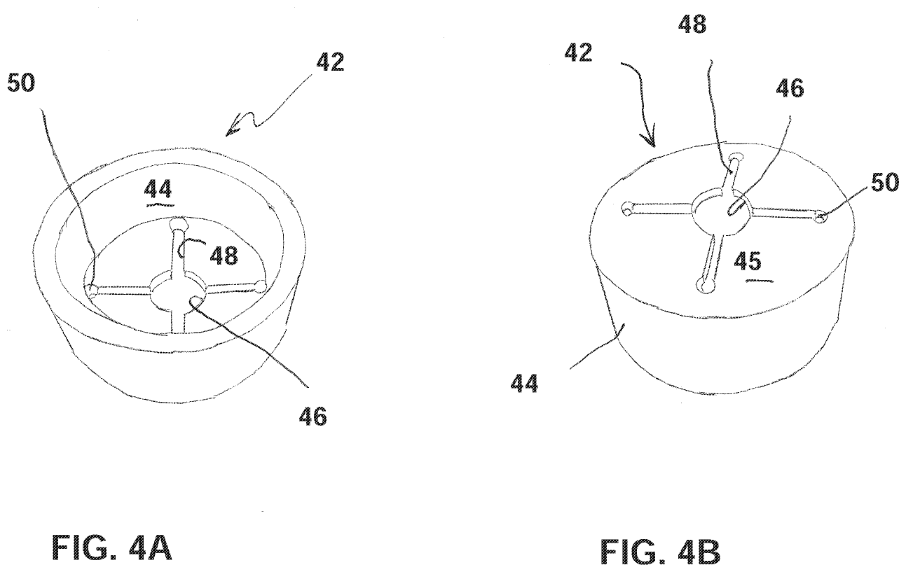

The main adapter body 42 is formed through conventional molding processes, and as illustrated in FIGS. 4A-4B, it includes a cylindrical sleeve 44 and an annular cap 45 integrally attached to an upper end of the sleeve. The annular cap 45 has a central opening 46 formed therein to receive a portion of a lamp assembly 22 therethrough. Optionally, a plurality of slits 48 may be formed in the annular cap 45 of the main adapter body 42, the slits extending radially outwardly from, and communicating with the central opening 46, in order to facilitate insertion and removal of the lamp assembly 22 in relation to the main adapter body. The slits 48 also allow part of the wire member 43 to be placed outside of the main adapter body 42 as described below.

In the embodiment of the main adapter body 42 depicted in FIGS. 4A-4B, four equally spaced slits 48 are shown, each of the slits ending in a rounded opening 50 which is slightly wider than other parts of the slit, in order to resist tearing of the main adapter body.

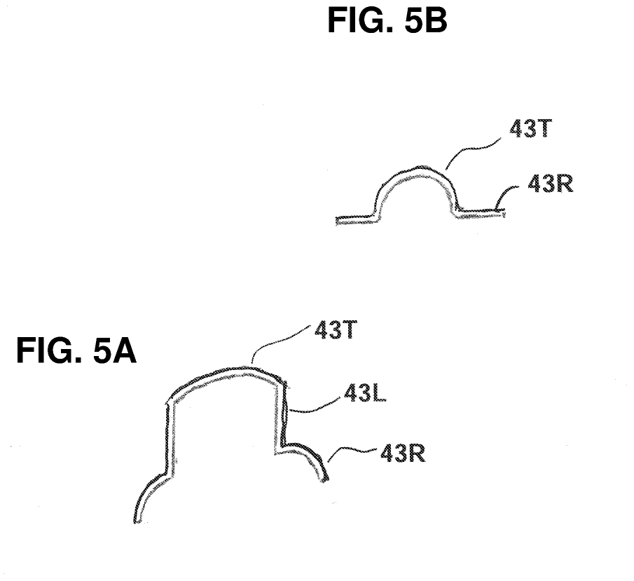

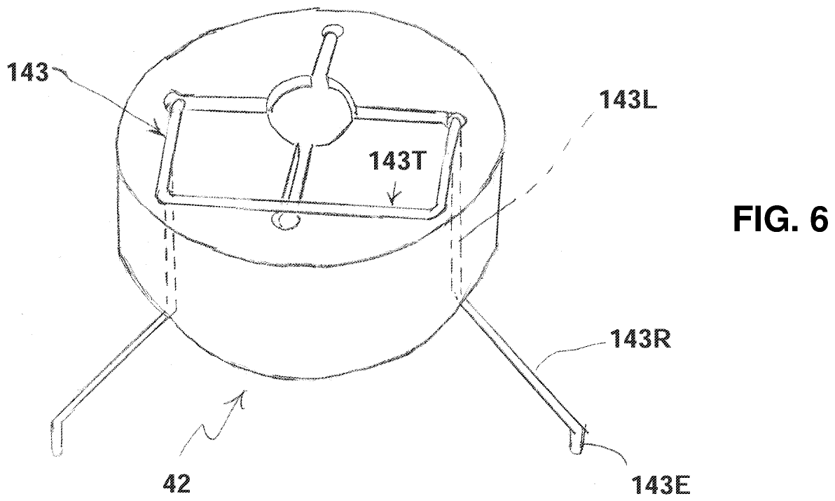

As shown in FIGS. 5a-5b, a first version of the resilient wire member 43 includes an arcuate, substantially C-shaped top portion 43T disposed in a first plane which may be oriented horizontally during use. The wire member 43 also includes a pair of parallel leg portions 43L extending downwardly from opposite ends of the top portion, and two retainer portions 43R extending outwardly from the bottom ends of the leg portions in opposite directions. Where used, the wire member 43 may be attached to the main adapter body 42 with the top portion disposed either inside of the adapter body, as shown in FIG. 2, or outside the adapter body and above the annular cap 45, as shown in FIG. 6.

Alternatively, if the main adapter body 42 is formed from a suitably stretchable elastomeric material and configured to fit on the neck 33 of the ornament 32 with an interference fit, the wire member 43 may be omitted.

Referring now to FIG. 6, a second version of the resilient wire member 143 is shown installed in the main adapter body 42. The resilient wire member 143 shown in FIG. 6 is similar to the wire member 43 of FIGS. 5A-5B as previously described, except that in this modified version, the top portion 143T is formed in a squared-off C-shape, and the retainer portions 143R extend outwardly away from the lower ends of the leg portions 143L in a substantially linear fashion, with each of the retainer portions having an optional, downwardly extending tip end 143E thereon.

Where the resilient wire member 43 or 143 is used with the top portion 43T or 143T outside of the main adapter body 42, the top portion may be slid out through two of the slits 48, and then the wire member may then be rotated by 90 degrees to place the top portion of the wire member in abutting contact with the cap 45, as shown.

The one or two-piece adapter design is configured to be attached once to an ornament such as that shown at 32, and to remain thereon, and the adapter 40 is designed to last the life of the ornament without any additional parts to lose, break, or mismatch. The superior holding design secures the ornament 32 to the lamp assembly 22 better than other known devices, and enables lighting of ornaments from the inside, without requiring power separate from that required to power the light string 20.

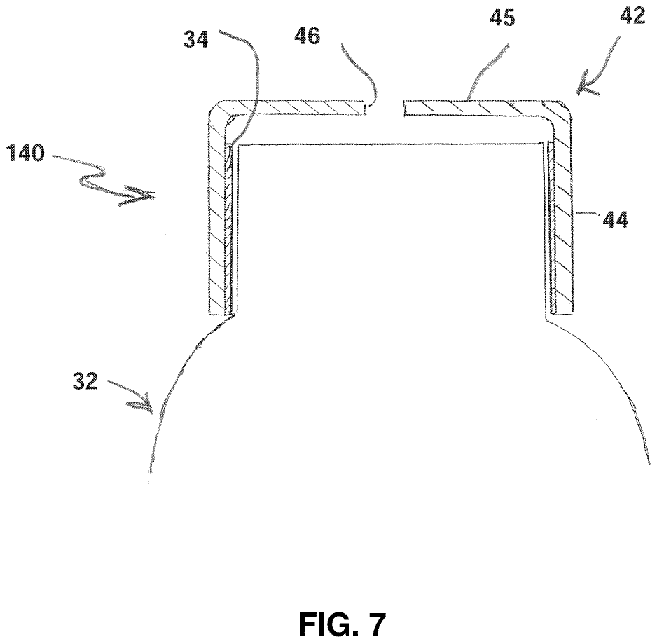

Referring now to FIG. 7, an adapter 140 according to a second embodiment of the present invention includes a main adapter body 42 as described above, but does not use a resilient wire member. Instead, the adapter 140 according to the second embodiment substitutes an adhesive material 34, such as a two-sided tape or adhesive foam strip, in place of the resilient wire member 43 inside of the cylindrical sleeve 44 of main adapter body 42, as an alternative attachment structure.

Where used, the adhesive material 34 may be temporarily covered with a peelably removable cover sheet (not shown), and where used, this cover sheet may be made of Mylar, plastic sheeting, treated paper, or other suitable material.

Another aspect of the present invention includes a translucent holiday ornament 32 having a hollow cylindrical neck portion 33, and the adapter 40 or 140 disposed on the neck portion.

Another aspect of the present invention provides a decorative holiday light string 20 having a multiplicity of light assemblies 22 interconnected by wiring W, and a plurality of translucent holiday ornaments such as those shown at 26, 28 30 and 32, each of the ornaments connected to one of the light assemblies 22 by the adapter 40 or 140 disposed on the neck portion 33 of each ornament.

### Method of Using the Adapter

Another aspect of the present invention provides a method of connecting a translucent holiday ornament 32 to a lamp assembly 22 of a light string 20.

The method according includes a step of placing the adapter 40 or 140 over a neck portion 33 of the holiday ornament 32.

Alternatively, the main adapter body 42 may be placed over the ornament without using the wire member 43, where the adapter body is configured to use an interference fit.

The method further includes a step of inserting a major portion of the lamp assembly, 22 including a bulb 25, into the holiday ornament 32 through a central opening 36 of the adapter 40 or 140.

The above method steps may be performed in any order.

Optionally, the method may include an initial step of sliding a top portion of a wire member 43 or 143 outwardly through two slits 48 formed in the adapter 40 or 140, and then rotating the wire member by 90 degrees to place the top portion of the wire member in abutting contact with the adapter cap 45.

To remove an ornament from a light, simply pull the light and ornament apart. A user can now relocate or store the ornament without hassles associated with other traditional hanger types.

Although the present invention has been described herein with respect to a number of specific illustrative embodiments, the foregoing description is intended to illustrate, rather than to limit the invention. Those skilled in the art will realize that many modifications of the illustrative embodiment could be made which would be operable. All such modifications, which are within the scope of the following claims, are intended to be within the scope and spirit of the present invention.

I claim:

1. An adapter for use in attaching a translucent holiday ornament to a single lamp assembly of a light string, said adapter comprising:
a main adapter body formed from a flexibly resilient material and including a cylindrical sleeve and an annular cap integrally attached to an upper end of the sleeve, the annular cap having a central opening formed therein to receive a portion of the lamp assembly therethrough; and
attachment structure for placement inside of the main adapter body, where the attachment structure is either a resilient wire member or an adhesive material.

2. The adapter of claim 1, wherein the attachment structure is a resilient wire member including an upper portion which is substantially C-shaped and disposed in a first plane, a pair of parallel connectors which are integrally formed with, and extend from opposite ends of the upper portion in directions which are substantially perpendicular to the first plane, and a pair of non-parallel retaining members configured for placement inside of said holiday ornament, the retaining members integrally formed with, and extending outwardly from ends of the connectors which are spaced away from the upper portion.

3. The adapter of claim 1, wherein the adapter cap has a plurality of slits formed therein extending radially outwardly from the central hole towards the cylindrical sleeve.

4. In combination, a translucent holiday ornament having a hollow cylindrical neck portion, the main adapter body of claim 1 disposed on the neck portion, and a resilient wire member including an upper portion which is substantially C-shaped and disposed in a first plane, a pair of parallel connectors which are integrally formed with, and extend from opposite ends of the upper portion in directions which are substantially perpendicular to the first plane, and a pair of non-parallel retaining members configured for placement inside of said holiday ornament, the retaining members integrally formed with, and extending outwardly from ends of the connectors which are spaced away from the upper portion.

5. A decorative holiday light string, comprising a multiplicity of light assemblies interconnected by wiring, and a plurality of translucent holiday ornaments, each of the ornaments connected to one of the light assemblies by the adapter of claim 1.

6. A method of connecting a translucent holiday ornament to a lamp assembly of a light string, said method comprising the steps of:
inserting a portion of a single lamp assembly through the central opening of the main adapter body of claim 1, and
inserting said portion of the lamp assembly into the holiday ornament by placing the main adapter body over a neck portion of the holiday ornament.

7. The method of claim 6, further comprising steps of inserting an upper portion of a resilient wire member through slits formed in the annular cap of the main adapter body, and rotating the wire member 90 degrees to place the upper portion into abutting contact with the annular cap.

8. An adapter for use in attaching a translucent holiday ornament to a single lamp assembly of a light string, said adapter comprising:
a main adapter body formed from a flexibly resilient material and including a cylindrical sleeve and an annular cap integrally attached to an upper end of the sleeve, the annular cap having a central opening formed therein to receive a portion of the lamp assembly therethrough, the adapter cap further having a plurality of evenly spaced slits formed therein extending radially outwardly from the central hole towards the cylindrical sleeve.

9. A decorative holiday light string, comprising a multiplicity of light assemblies interconnected by wiring, and a plurality of translucent holiday ornaments, each of the ornaments connected to one of the light assemblies by the adapter of claim 8.

10. A method of connecting a translucent holiday ornament to a lamp assembly of a light string, said method comprising the steps of:
inserting a portion of a single lamp assembly through the central opening of the main adapter body of claim 8, and
inserting said portion of the lamp assembly into the holiday ornament by placing the main adapter body over a neck portion of the holiday ornament.
